(19) United States
(12) Patent Application Publication
(10) Pub. No.: US 2020/0016638 A1
(43) Pub. Date: Jan. 16, 2020

(54) PIPE CLEANER M4 TOOL

(71) Applicant: STEVEN PHILIP MARKESINO, RICHMOND, TX (US)

(72) Inventor: STEVEN PHILIP MARKESINO, RICHMOND, TX (US)

(21) Appl. No.: 15/996,066

(22) Filed: Jul. 16, 2018

(51) Int. Cl. B08B 9/049; B08B 9/043

(52) U.S. Cl. CPC B08B 9/049; E03C 1/302; B08B 9/0436

(57) ABSTRACT

A pipe cleaner M4 tool comprising an elongated body having 30 degrees arch, a first end and a second end. Further, the first end and the second end have respective sharp edges to facilitate scrapping action. In addition, the elongated body is biased towards a curved shape, and facilitates spring like action, when moved in a clogged component, to aid in cleaning. The pipe cleaner tool is made of Polylactic Acid (PLA) material.

### DETAILED DESCRIPTION OF THE EMBODIMENTS

Detailed embodiments of the present disclosure are described herein; however, it is to be understood that disclosed embodiments are merely exemplary of the present disclosure, which may be embodied in various alternative forms. Specific process details disclosed herein are not to be interpreted as limiting, but merely as a representative basis for teaching one skilled in the art to variously employ the present disclosure in any appropriate process.

The terms used herein are for the purpose of describing exemplary embodiments only and are not intended to be limiting. As used herein, the singular forms “a,” “an,” and “the” are intended to include the plural forms as well, unless the context clearly indicates otherwise. It will be further understood that the terms “comprises” or “comprising,” when used in this specification, do not preclude the presence or addition of one or more components, steps, operations, and/or elements other than a mentioned component, step, operation, and/or element.

The embodiments of the present disclosure will now be described more fully hereinafter with reference to the accompanying drawings, which form a part hereof, and which show, by way of illustration, specific example embodiments. The following detailed description is not intended to be taken in a limiting sense.

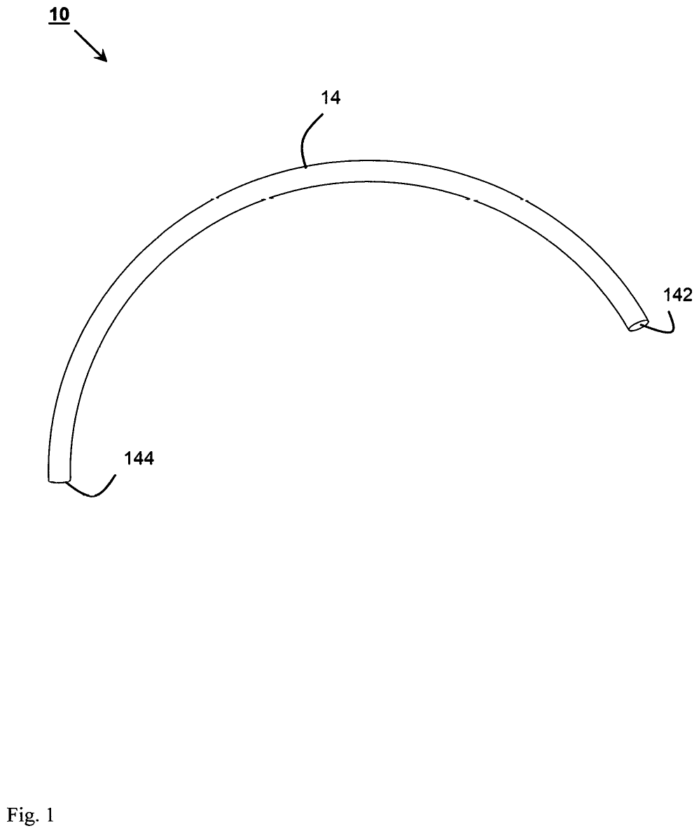

FIG. 1 illustrates a pipe cleaner M4 tool 10 (hereinafter referred to as “pipe cleaner tool 10”), in accordance with an embodiment of the present invention. The pipe cleaner tool 10 is adapted to be used for cleaning pipes, pipettes, bolts, receivers, slides, clips etc. that may be clogged due to dirt, tar, grease or sand accumulation. As shown in FIG. 1, the pipe cleaner tool 10 comprises an elongated body 14. The elongated body 14 is in a form of, but not limited to, a 30 degrees arch. The elongated body 14 is biased towards a curved shape and therefore stores energy to facilitate spring like action. In other words, if a user applies a force on the elongated body 14, then the elongated body may form a shape of a coil spring, just like a spring, the elongated body 14 will return to the original position and re-achieve the curved shape. The elongated body 14 is envisaged to be flexible.

Further, the elongated body 14 may have, but not limited to, a solid cylindrical shape and circular cross section. The elongated body 14 may have a length in the range of, but not limited to, 5 inches to 36 inches and may have a diameter of about 1.75 mm. In addition, pipe cleaner tool 10 has a first end 142 and a second end 144 on the opposite sides of the elongated body 14. Both the first end 142 and the second end 144 have respective sharp edges cut out on the elongated body 14 to facilitate scrapping action. The material for making the pipe cleaner tool 10 (or the elongated body 14) may be, but not limited to, solid Polylactic Acid (PLA) material. In general, the Polylactic Acid (PLA) is biodegradable and has characteristics similar to polypropylene (PP), polyethylene (PE), or polystyrene (PS). PLA may be derived from renewable resources like corn starch or sugar cane. Cost effectiveness is another advantage of using PLA as a material for pipe cleaner tool 10. The process used for making the pipe cleaner tool 10 may be, but not limited to, extrusion of PLA.

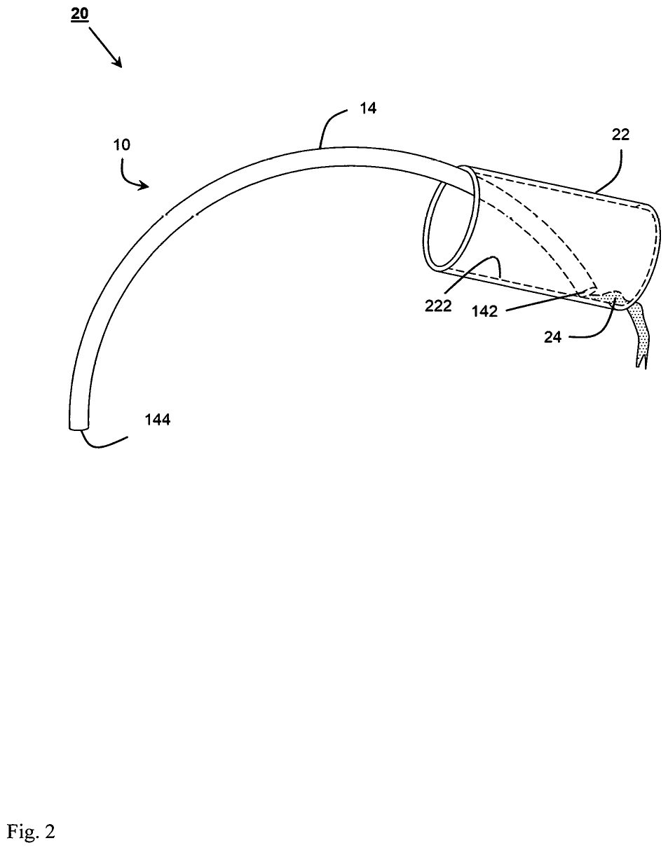

FIG. 2 illustrates an implementation 20 of the pipe cleaner tool 10 for cleaning a clogged component, in accordance with an embodiment of the present invention. In the embodiment shown in FIG. 2, the pipe cleaner tool 10 is being used to clean a clogged pipe 22. One of the first end 142 or the second end 144 may be inserted into the pipe 22 clogged with dirt 24 on an internal surface 222 of the pipe 22. The first end 142 having a sharp edge comes in contact with the internal surface 222 of the pipe 22 and the pipe cleaner tool 10 may be pushed/slid inside the pipe 22 so as to perform the scrapping action using the sharp edge. As the pipe cleaner tool 10 is pushed inside the pipe 22, the elongated body 14 moves along the internal surface 222 of the pipe 22 in a shape similar to a coil spring. Then, the pipe cleaner tool 10 may be rotated/turned while pushing to enable 360-degree cleaning of the internal surface 222 of the pipe 22 using the sharp edge as well as the sides of the pipe cleaner tool 10. After the cleaning is complete, the pipe cleaner tool 10 may be taken out from the pipe 22 and wiped with a clean cloth. Then the pipe cleaner tool 10 can be reused with other components that require cleaning. Similar method may be applied for cleaning other components like bolts, pipettes, slides, clips etc.

The present invention offers a number of advantages. Firstly it provides a cost effective and easy to implement tool for cleaning components clogged with dirt, sand, tar or grease. Additionally, the PLA allows the pipe cleaner tool to be flexible and the curved and flexible elongated body of the pipe cleaner tool enables a spring-like movement to allow the 360-degree cleaning and scrapping of the internal surface of the pipe. This provides an advantage over the prior art that used metallic pipe cleaners which are rigid. Also, the flexibility of the elongated body allows insertion of one of the first end or the second end into components having complicated shapes/bends to perform cleaning action.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the disclosure is anticipated to hold on to all other such alternatives, modifications, and variations that fall within the scope of the present disclosure and appended claims.

1. A pipe cleaner M4 tool comprising:
an elongated body having 30 degrees arch, a first end and a second end;
wherein the first end and the second end have sharp edges to facilitate scrapping action; and
wherein the elongated body is biased towards a curved shape and facilitates spring like action, when moved in a clogged component, to aid in cleaning.

2. The pipe cleaner M4 tool as claimed in claim 1, wherein the elongated body is made of solid Polylactic Acid (PLA) material.
